(19) United States
(12) Patent Application Publication
(10) Pub. No.: US 2010/0161391 A1
(43) Pub. Date: Jun. 24, 2010

(54) VARIABLE RATE TRANSPORT FEES BASED ON VEHICLE EXHAUST EMISSIONS

(75) Inventors: Duncan Ashby, Surrey (GB); Rick A. Hamilton, II, Charlottesville, VA (US); Naveen Lamba, Haymarket, VA (US); Colin Fung Wan Lim, Twickenham (GB); Benjamin G. Morris, Falls Church, VA (US); James W. Seaman, Falls Church, VA (US)

Correspondence Address: Driggs, Hogg, Daugherty & Del Zoppo Co., L.P.A., 38500 CHARDON ROAD, DEPT. IEN, WILLOUGHBY HILLS, OH, 44094, US

(73) Assignee: International Business Corporation, Armonk, NY (US)

(21) Appl. No.: 12/341,009

(22) Filed: Dec. 22, 2008

(51) Int. Cl. G07B 15/02; G01N 7/00; G06Q 50/00; G06Q 30/00; G06Q 20/00

(52) U.S. Cl. 705/13; 73/23.31; 705/400

(57) ABSTRACT

This invention provides a system and method of detecting and responding to individual vehicle exhaust emissions such that a vehicle producing exhaust emissions containing pollutants in excess of required standards is assessed a higher toll or other fees than non-offending vehicles. Upon correction of the problem when emissions are determined to be within acceptable ranges, the fees are re-adjusted. Vehicle fees can be assessed on a sliding scale regardless of “acceptable thresholds” whereupon a higher levels of pollution emitted by the vehicle require payment of a higher fee than that paid by a vehicle with a lower level. Sensors may be installed within individual vehicles, or may be externally mounted to detect emissions. The use of a computer program and program code may be used for collecting and quantifying the level of pollution in the emissions and for assessing a suitable fee based on the level.

### FIELD OF THE INVENTION

The following invention relates generally to the field of transportation and allocation of vehicle user costs based upon contribution of harmful emissions by a motor vehicle to the environment.

### BACKGROUND OF THE INVENTION

The automobile is by far the most common and generally desired form of daily transportation for commuters of all kinds. The number of vehicles on the roads continues to grow exponentially, where in some areas, traffic congestion and pollution from exhaust emissions has become very problematic. These vehicles include cars, vans, trucks, buses, SUVs and other ground vehicles that utilize gasoline or diesel-powered engines for propulsion. Travelers have many differing transit requirements, options, and habits. Management of transit thoroughfares include public roads, regional and intrastate highways, interstate highways, public toll and access roads, private toll and access roads, and all forms of public/mass transportation. An important issue when considering transit issues is the impact of each existing, planned, and proposed transit system on the environment. One overriding goal is to increase the green nature, i.e. the earth/environment friendliness, of regional transit systems, thus having the same impact on a national level. In viewing these transit requirements as a whole, many municipalities have difficulty balancing the requirements and desires of commuters against such things as traffic congestion, environmental impact, availability and use of mass transit, and equitable distribution of transit costs.

In addition to roadway vehicles, other emitters of harmful pollutants include trains, boats and aircraft. Collectively, these vehicles can and do contribute significantly to the condition of the environment.

### SUMMARY OF THE INVENTION

The present invention introduces real-time vehicle exhaust emissions testing and reporting system that monitors individual vehicles for pollutants in the exhaust. If excess pollutants are detected, operational charges such as toll charges and parking fees, along with governmental license renewals and the like are increased for offending vehicles. This invention provides an incentive to commuters to maintain well running vehicles, while imposing higher monetary or non-monetary demands on those commuters who pollute the air with improperly maintained and/or inefficient vehicles.

In one aspect, a system and method serve to promote green commuting through the use of a sensor to sense motor vehicle exhaust emissions. These exhaust emissions are analyzed to determine the level of pollutants in the exhaust emissions. This exhaust emission information is transmitted or forwarded to a fee assessor which calculates or determines the amount of a vehicle use fee (collectively referred to as “transport fee” or “use fee”) based on the level of pollution in said exhaust emissions. The fee information relating to the emission levels is made available to a collection agency such as a highway toll authority or commission or a vehicle parking facility which is responsible for collecting the calculated vehicle use fee from the vehicle owner or operator.

In another aspect, the invention includes a computer executable program code and a method for producing a program code. The code is stored on a computer readable medium and is executed on a computer system. The program code includes instructions which, when executed on the computer system, cause the computer system to obtain vehicle exhaust emission information from an emission sensor. It then proceeds to quantify the level of pollution in the exhaust emissions. The program then forwards information relating to the emission levels to a fee collection agency such as a toll agency or parking facility responsible for the collection of a fee based on the level of pollution.

Yet another aspect of the invention is a method whereby a service provider deploys an application for collecting exhaust emission information of vehicles in operation. The level of pollution in the exhaust emission of each vehicle is quantified, and a transport fee is assessed based on the level of pollution. A vehicle fee collection agency such as toll or parking systems or governmental or non-governmental licensing agencies are notified of the fees or tolls that should be assessed for a given vehicle based upon its level of pollutants in the exhaust emission.

### BRIEF DESCRIPTION OF THE DRAWINGS

These and other features of this invention will be more readily understood from the following detailed description of the various aspects of the invention taken in conjunction with the accompanying drawings in which:

FIG. 1 is a block diagram illustrating the logical elements of an exhaust emission detector and reporting system in accordance with the present invention;

FIG. 2 is a flow diagram of the steps of the present invention; and

FIG. 3 illustrates a computer structure useful in the present invention.

The drawings are not necessarily to scale. Instead, the drawings are merely schematic representations, not intended to portray specific parameters of the invention. The drawings serve to depict only typical embodiments of the invention, and therefore should not be considered as limiting the scope of the invention. In the drawings, the same numbers are used to represents like elements.

### DETAILED DESCRIPTION OF THE INVENTION

For convenience purposes, the Detailed Description of the Invention has the following sections.

### I. General Description

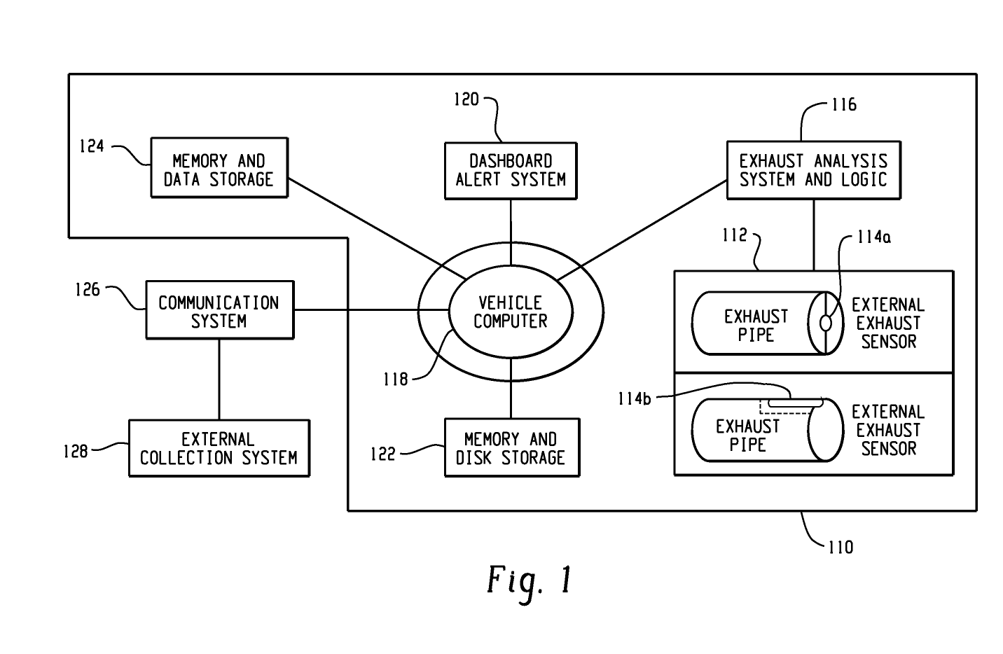

This invention introduces an active vehicle exhaust monitoring system, whereby at any given point in time, vehicle exhaust can be analyzed for pollutants in excess of permissible levels. The term “vehicle” encompasses automobiles as well as buses, boats, trains, lorries and any apparatus configured to carry occupants and passengers along dedicated thoroughfare infrastructures (e.g. highways or railroad tracks), and which also may define a thoroughfare through their regular paths and schedules (e.g. a shipping channel or inter-coastal waterway). In one embodiment, such an exhaust analyzer element would be installed in a vehicle as a standard integral component during factory assembly. However, it also may include an after-market device. Most modern land vehicles are equipped with a relatively sophisticated computer system. The exhaust analysis and reporting logic could be incorporated into the existing computer system. On the other hand, a stand-alone system including an exhaust gas probe and logic unit could be installed as an after-market system. Communication to and from a new device and system could be achieved using the numerous existing techniques, protocols, and methods. FIG. 1 below is a high level diagram of the logical elements of this invention. Also included is an exhaust emission detector which is mounted externally of a vehicle and which measures pollutant levels as the vehicle is passed through a confined space such as a tunnel.

Turning now to FIG. 1, in accordance with the logic shown in this diagram, a vehicle is represented at 110. Samples are periodically taken of emissions from the vehicle's exhaust pipe 112. An exhaust emission sensor or analyzer 114a is positioned outside of the exhaust pipe 112, or is located as an integral part within the pipe itself as shown in 114b. An exhaust analysis system and logic module 116 collects data and transmits it to a vehicle computer 118 which may be integral to the vehicle. The logic module 116 can be connected to a thermostat, engine speed indicator, or timer such that samples would not be taken when the vehicle exhaust system temperature is cold, the vehicle is not moving, or the vehicle is moving very slowly, as each of these situations can cause an emissions reading that may temporarily fall outside of acceptable ranges. The system would, however, take a reading during one or more of these situations if the last time interval had exceeded the allowable maximum interval between readings.

Additionally, logic may require the exhaust emission testing system to check for all of the same pollutants that are analyzed during a city, county, or state emissions system test, or to test only a meaningful and representative subset of these pollutants such as carbon dioxide, sulfur compounds, or particulates. After the first interval, all subsequent tests that produce the same, or similar results (readings not exact, but the variations are minor and the readings still pass, or fail), then the new results can simply replace the previous results. If the result change is significant, or changes the status from ‘passed’ to ‘failed’, or ‘failed’ to ‘passed’, the new result may not overwrite the previous test and should be stored in memory in conjunction with the previous reading or readings.

The on-board computer 118 may include a link to a dashboard alert system 120 which can include a visual signal, audible signal or both. The computer typically will include memory and disk storage 122 as well as data storage 124. The computer 118 may transmit vehicle test information to an external communication system 126 which in turn corresponds with an external toll or fee collection system 128 as previously mentioned.

All stored results would also include a counter indicating the number of times the change in results has occurred, and a time stamp on the current sample data and result. Alternatively, every test and result could be stored. Either way, the offending commuter could be penalized for each offense either based on numerous stored failure results, or on the counts associated with failed results. The test interval and fine interval for a failed test may be the same. Alternatively, the use of incrementally increasing variable rate fees can be used to discourage a repeat offender from continuing to operate a pollution-causing vehicle. Still further, the test intervals can be treated as independent and numerous tests may execute before a fine is assessed.

Rates randomly and/or deterministically distributed to toll thoroughfare travelers may be published to travelers using a variety of means. For example, as a vehicle travels along on or approaches an ingress point to the toll road, it might pass through an exhaust emission analyzer or a reader that receives emission data sent to it by the on-board computer or reporting system within the vehicle. Notice in real-time of a toll rate may then be provided to a vehicle occupant through a variety of user-based visual or auditory means. Illustrative but not exhaustive examples of notification may include a in-dash display and audio information provided by an automobile data or GPS system such as an OnStar® or Garmin® system; ONSTAR is a trademark of the OnStar Corporation in the United States, other countries, or both; and GARMIN is a trademark of Garmin Ltd. in the United States, other countries, or both). The information can be over the radio using a broadcast or satellite radio system. A personal data device such as a personal digital assistant (PDA) device, a personal computer or a cellular telephone device. Yet another means is by communications from a vehicle toll transponder provided at a toll booth or along the toll road. Each of the devices may be in wired or wireless data communication with a toll thoroughfare authority or service provider who provides toll rate assignments, distributions or updates to any one of the devices.

Tolls may be collected/rewarded using manual and automated devices and systems, including fare boxes and automated toll collection systems, for example incorporating systems, such as EZ-Pass®, a trademark of the EZ-Pass Interagency Group in the United States and/or other countries.

Global Positioning Satellite (GPS) systems may also be used to track vehicle road use independent of toll road use and associated toll collection system systems, thus extending toll, fees and credit awards according to the present invention beyond conventional toll thoroughfares. Such automated embodiments offer advantages in enabling simplified implementation, management, and modification of variable rate tolls

Toll collection systems and GPS systems may also comprehend municipal parking collection systems; vehicle service, fueling or charging stations, for example incorporated into automated fueling pumps or charging stations. Transport-related fees may also be assessed and collected through other payment and debiting systems and events, for example upon payment of taxes, renewal of a drivers license or vehicle registration, payment of regulated utility bill, and the like; or tolls may be invoiced for remittance by the vehicle owner or operator, or even passenger thereof.

Wired and wireless communications are well known in the art, and this invention is able to draw upon a known communication system to satisfy the required communication component. For example, an active transponder in the vehicle would be updated by the emission test system each time a test failure occurred and would subsequently upload this data to an electronic collection (EC) system. The EC system could include, among many other possibilities, a toll collection system, a municipal parking collection system, a service station EC system (such as those used to do required annual vehicle and emission inspections), a state motor vehicle registration bureau, or a new EC system established specifically for this purpose using distributed collection readers. A fee might also be assessed when other manual collections occur, such as upon payment of taxes, renewal of driver's license, payment of regulated utility bill, and the like, or, fines could simply be mailed in the same manner as a parking ticket. Adjudication of disputed fines or assessments would also likely follow the method employed for disputing parking tickets. It should be understood that communication systems yet to be developed are also contemplated as being suitable for use in connection with the present teachings.

The dashboard alert system can be used to provide an indicator that the exhaust emissions are normal, not normal but within limits, or are out of limits and have failed the most recent test. An on-board computer system containing a display screen could provide the same data as a dash indicator, in addition to current and project fine data if a failure has occurred. The communication system could also be used to send such data to any of the commuter's pervasive devices.

Fines could increase for repeat offenses or violation of emission standards or regulations. Possibly, the fines would increase for repeat offenses once only after a commuter has been made aware of the problem. Alternatively, no fines would be assessed until the commuter has been made aware of the system. Awareness could include an indicator light on the dash board, an audible signal, a previous fine assessment, a previous fine payment, or transmission of failure information to the commuter's pervasive device. Fines could continue to increase each mile driven after a failure warning has been given.

All of the logic required to analyze the collected exhaust emission data could be included in the original equipment vehicle computer system or after market system. Alternatively, the vehicle system would simply do the data collection and storage, and an external system would perform the analysis and determine the results and any resultant fines.

The emissions data could be removed from the vehicle and the counter restarted once the data has been uploaded to an external system. Alternatively, the data would be retained in summary form. The entirety of the data could be retained, or the data log would be circular, and upon reaching the end of the log, the oldest data would be overwritten with the new data. If all of the data is retained, a marker in the log would indicate the point of the last reading via an external collection system.

The dash indicator light could also illuminate and cause assessment of a fine if the monitoring system is tampered with, or not operational. In another embodiment, only specific vehicles would be required to employ the system.

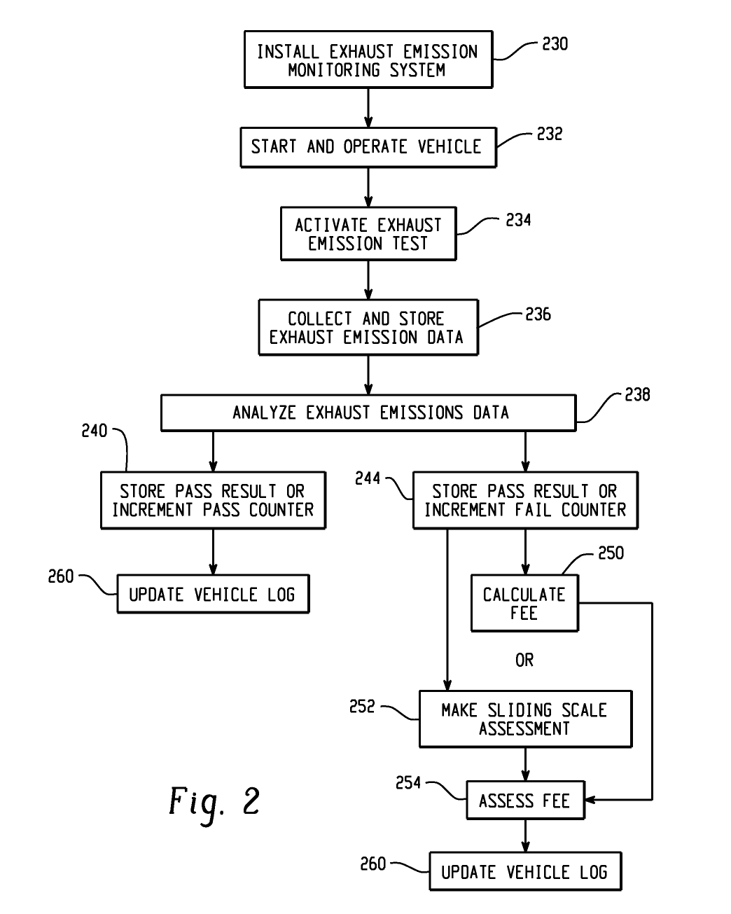

Referring now to FIG. 2, the following is an example of the technical logical flow and process steps of the present invention. First, the vehicle is equipped at 230 with an exhaust emission monitoring system of the type shown in FIG. 1 as 112. Then, at 232, a person starts and operates the vehicle. After an initial warm-up period, the exhaust emission test is activated at 234, and then operates either periodically or continuously. Exhaust emissions data is collected and stored at 236 as a record log, either on the vehicle or in a remote location. The exhaust emissions data is analyzed at 238 and the result is determined and stored at 240 or 244.

Depending on the results, one of the following will occur
a pass result is stored or a pass counter is incremented at 240, after which the vehicle log is updated at 260. Then, no further action needed. OR
a fail result is stored or fail counter is incremented at 244;
a fee is calculated at 250 and queued upon elapse of failure criteria or interval OR
measurements are utilized (252) for sliding scale assessment without explicit Pass/Fail denotation. The external fee collection source is utilized at 254 to assess a fee to the vehicle or the driver with chargeable failures. Finally, the vehicle log record is updated at 260. It should be noted that some of the above steps may be reordered, without loss of applicability. Thus, the vehicle log records may be updated at various points in the process.

### II. Computer Implementation

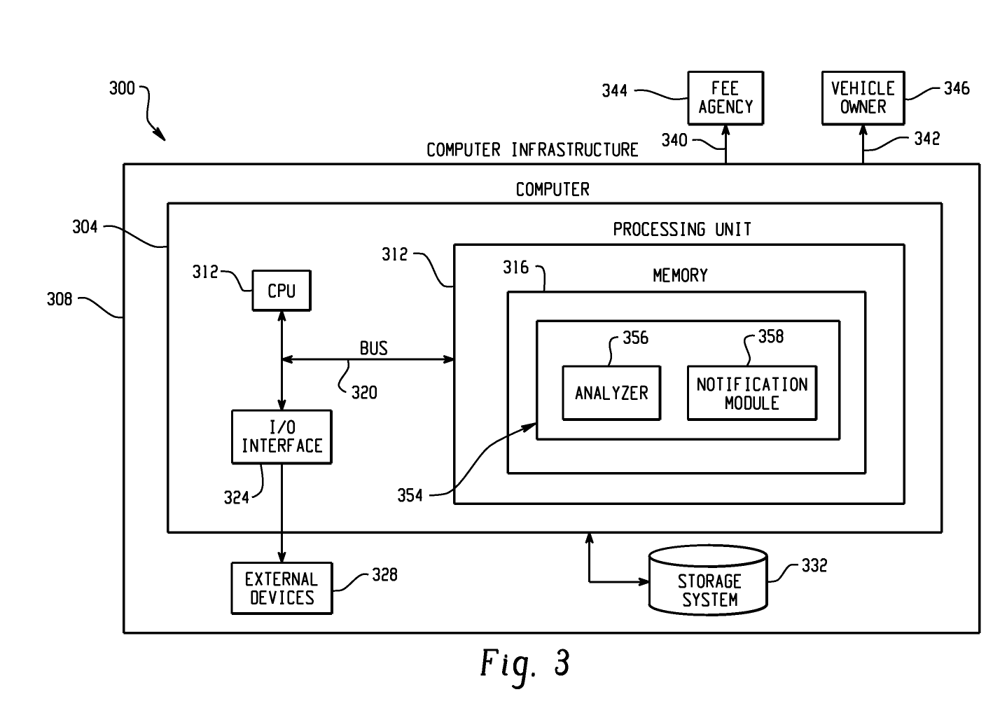

As shown in FIG. 3, a computer infrastructure 300 includes a computer 304. The system 304 comprises a processing unit (CPU) 312, a memory 316, a bus 320, and input/output (I/O) interfaces 324. Within the memory 316 may be installed the vehicle adverse driving module 354 including an exhaust emission analyzer 356, a notification module 358, and other components as needed or desired. Further, the computer 304 is shown in communication with external I/O devices/resources 328 and storage system 332. In general, the processing unit of the computer 304 executes computer program code, such as the code to implement the parts detection system, which is stored in the external memory 328 and/or database storage system 332.

While executing computer program code, the computer 304 can read and/or write data to/from the memory 316, the storage system 332, and/or the I/O interfaces 324. The bus 320 provides a communication link between each of the components in computer 304. The external devices 328 can comprise any of the previously mentioned components, such as the sensor or detector, the reader, the data steam converter and the user notification module.

Further, I/O interfaces 324 can comprise any system for exchanging information with one or more of the external devices 328. Still further, it is understood that one or more additional components (e.g., system software, math co-processing unit, toll collection system.) not shown in FIG. 3 can be included in the computer 304. However, if computer 304 comprises a handheld device or the like, it is understood that one or more of the external devices 328 (e.g., a display) and/or the storage system 332 could be contained within computer 304, not externally as shown. The computer system can further include wired or wireless connections 340, 342 and bus to allow it to communicate outside of the vehicle to, for example, a fee collection agency 344 or to the vehicle owner 346. This capability allows the transfer of updated information for any of the purposes heretofore described.

The storage system 332 can be any type of system (e.g., a database) capable of providing storage for information under the present invention. To this extent, the storage system 332 could include one or more storage devices, such as a magnetic disk drive or an optical disk drive. In another embodiment, the storage system 332 includes data distributed across, for example, a local area network (LAN), wide area network (WAN), or a storage area network (SAN) (not shown). Also, although not shown, additional components, such as cache memory, communication systems, system software, toll collection system, may be incorporated into computer 304.

The invention provides a business method that performs the process steps of the invention on a subscription, advertising, and/or fee basis. That is, a service provider could offer to manage the monitoring or reporting of the exhaust emission data. In this case, the service provider can create, maintain, support, toll collection system, a computer 304 on-board a vehicle. The computer 304 performs the process steps of the invention for one or more customers, such as various toll or fee collection agencies. In return, the service provider can receive payment from the customer(s) under a subscription agreement

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of an application/software program, component software/a library of functions, an operating system, a basic I/O system/driver for a particular computing and/or I/O device, and the like.

The computer 304 is only illustrative of various types of computer infrastructures for implementing the invention. For example, in one embodiment, the computer 304 comprises two or more computing devices (e.g., a server cluster) that communicate over a network to perform the various process steps of the invention. Moreover, computer 304 is only representative of various possible computer systems that can include numerous combinations of hardware.

To this extent, in other embodiments, computer 304 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Moreover, the processing unit or CPU 312 may comprise a single processing unit, or be distributed across one or more processing units in one or more locations, e.g., on a client and server. Similarly, the memory 316 and/or the storage system 332 can comprise any combination of various types of data storage and/or transmission media that reside at one or more physical locations.

While shown and described herein as a method and system for detecting adverse operating conditions relating to the operation of a vehicle, it is understood that the invention further provides various alternative embodiments. For example, in one embodiment, the invention provides a computer-readable/useable medium that includes computer program code to enable a computer infrastructure to monitor all systems in the vehicle. To this extent, the computer-readable/useable medium includes program code that implements each of the various process steps of the invention.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for reducing levels of harmful exhaust emissions from the exhaust system of motor vehicles, comprising:
sensing vehicle exhaust emissions;
analyzing said emissions to determine a level of pollutants in the exhaust emissions;
transmitting exhaust emission information to a fee assessor;
calculating an amount of a vehicle use fee based on the level of pollution in said exhaust emissions; and
providing information relating to the calculated vehicle use fee to a fee collection agency.

2. The method according to claim 1 wherein a vehicle exhaust emissions sensor is mounted within the exhaust system of the vehicle.

3. The method according to claim 1 wherein a vehicle exhaust emissions sensor is located outside of the exhaust system of the vehicle.

4. The method according to claim 1 wherein the fee assessor is a fee collection agency.

5. The method according to claim 1 wherein the fee assessor is a government agency responsible for vehicle registration records.

6. A system for reducing levels of harmful exhaust emissions from motor vehicles, comprising:
a sensor to measure vehicle exhaust emissions;
an analyzer for determining levels of pollutants in the exhaust emissions;
a transmitter for forwarding exhaust emission information to a fee assessor; and
a fee calculator for determining an amount of a vehicle use fee based on the level of pollution in said exhaust emissions.

7. The system according to claim 6 wherein the sensor is mounted within an exhaust system of the vehicle.

8. The system according to claim 6 wherein the sensor is located outside of an exhaust system of a vehicle.

9. The system according to claim 6 wherein the fee assessor is a fee collection agency.

10. The system according to claim 6 wherein the fee assessor is a governmental agency responsible for vehicle registration records.

11. In a computer system, a computer program, comprising:
a computer-readable medium; and
a computer executable program code stored on the computer-readable medium, the program code capable of being deployed by the system to:
obtain vehicle exhaust emission information from an emission sensor;
quantify the level of pollution in exhaust emission; and
transmit information relating to the pollution levels to a vehicle fee collection agency responsible for the collection of a fee based on the level of pollution.

12. In the computer system according to claim 11, said computer program is stored in a computer that comprises an integral part of the vehicle.

13. In the computer system according to claim 12, the computer code calculates a transport fee based on the level of pollution in said exhaust emissions.

14. In the computer system according to claim 12, said program is further deployed to quantify the level of pollution in the exhaust emissions.

15. The system according to claim 12 wherein the system transmits information relating to the emission levels to a fee collection agency.

16. A method, comprising:
producing computer executable program code;
storing the code on a computer readable medium; and
executing the program code on a computer system, the program code comprising instructions which, when executed on the computer system, cause the computer system to:
obtain vehicle exhaust emission information from an exhaust emission sensor;
quantify a level of pollution in the exhaust emissions;
transmit information relating to the pollution level to a fee collection agency; and
assess a vehicle user fee based on the level of pollution in said exhaust emissions.

17. The method according to claim 16, said computer program is stored in a computer that comprises an integral part of the vehicle.

18. The method according to claim 17, said program is further deployed to quantify the level of pollution in the exhaust emissions.

19. The method according to claim 16, wherein the program calculates a transport fee based on the level of pollution in said exhaust emissions.

20. The method according to claim 17 wherein the program transmits information relating to the emission levels to a fee collection agency.

21. A method of providing a service of:
collecting exhaust emission information from a vehicle in operation;
quantifying a level of pollution in the exhaust emissions of said vehicle; and
assessing a user-based fee on the vehicle based on the level of pollution in said exhaust emissions.

22. The method according to claim 21 wherein the service is provided for and on behalf of a highway toll commission.

23. The method according to claim 21 further including the service of notifying fee collection sources of the amount of fees or tolls to be assessed for a given vehicle based on the level of pollution in the exhaust emission of the vehicle.

24. The method according to claim 21 wherein the service further provides information to the vehicle relating to the pollution and the amount of the user-based fee.
